(19) United States
(12) Patent Application Publication
(10) Pub. No.: US 2024/0087465 A1
(43) Pub. Date: Mar. 14, 2024

(54) INTERACTIVELY TEACHING/IMPROVING LANGUAGE SKILLS BY GENERATING A VISUALLY CONNECTED SEQUENCE OF IMAGES

(71) Applicant: AMPLIO LEARNING TECHNOLOGIES LTD., Herzliya (IL)

(72) Inventors: Aric KATZ, Haifa (IL); Yair SHAPIRA, Haifa (IL)

(21) Appl. No.: 18/367,037

(22) Filed: Sep. 12, 2023

Related U.S. Application Data
(60) Provisional application No. 63/406,086, filed on Sep. 13, 2022.

(51) Int. Cl. G09B 5/02; G06F 40/253; G06T 11/00

(52) U.S. Cl. CPC G09B 5/02; G06F 40/253; G06T 11/00; G09B 19/06

(57) ABSTRACT

Provided herein are computer implemented methods and systems for interactively teaching or improving language skills of users, by generating a visually connected sequence of images, based on various input form the user, including, a selection of a persona and activity, and a language demonstration that describes the selected activity.

### CROSS REFERENCE TO RELATED APPLICATIONS

This application claims the benefit of priority of U.S. Provisional Patent Application No. 63/406,086, filed Sep. 13, 2022, the contents of which are all incorporated herein by reference in their entirety.

### FIELD OF THE INVENTION

The invention is in the field of interactively teaching/improving language skills to kids in special education or standard education or anyone in the general population who wants to learn a second language. In some embodiments, a visually connected sequence of images is generated.

### BACKGROUND OF THE INVENTION

Many children and adults find learning a new language or improving their language skills to be tedious. Children with educational challenges and/or special needs are even more in need of creative ways to learn or improve language since they do not interact well with the normal need to be educated outside of the ordinary method of education.

### SUMMARY

According to some embodiments, there are provided herein systems and computer implemented methods for interactively teaching or improving language skills in users in need thereof, for example, by generating a visually connected sequences of images.

As detailed herein, the inventors have discovered that students (users, such as children, children with special needs, or others), respond better when the educational method utilized to teach them language involves having them communicate about themselves and what they are doing and experiencing. The inventors have also discovered that by generating a visually connected sequence of images that embodies the user's actual life experience, the language acquisition of the student or child is greatly accelerated. Inventors have further discovered that the language acquisition is even more enhanced and accelerated when the sequence of images embodying the life experience is presented in a stimulating format. Inventors have further discovered that inclusion of stimulating activities that directly involve and make use of one or more of the five senses of the student or child enhances the language acquisition.

One embodiment is a computer implemented method for interactively teaching/improving language skills by generating a visually connected sequence of images, the method comprising: prompting, by a bot/processor, a user input of a selection of a persona and of an activity previously performed by the user; generating, by a processor, an image of a character or an object matching, in activity or pose, the selected persona and activity; prompting, by a bot, an input from a user of a language demonstration that describes the selected activity of the user and that has multiple parts; verifying an integrity of the input, using Artificial intelligence (AI), for example, conversational artificial intelligence software/algorithms/models, for example, by recognizing key verbs and checking for errors, and providing at least one of feedback and a score measuring a language skill of the input; for each part of the language demonstration, using the conversational artificial intelligence software and the generated image of the character or object to match the key verbs and selected persona with a plurality of newly generated proposed images presented in a visual group to the user such that a series of selected matching images is configured to collectively form a visually connected sequence of images, and such that each plurality of newly generated proposed images presented beginning with a second plurality of proposed images is configured to integrate data from the user's previous one or more selections of images; and generating from the user selections, using the processor and artificial intelligence, the visually connected sequence of images.

In some embodiments, the prompting includes at least two of the following: what the user did, where the user was, with whom the user interacted, what happened to the user and how the user felt.

In some embodiments, the language demonstration is a story.

In some embodiments, the language demonstration is in the form of physical gestures.

In some embodiments, the language demonstration is in the form of any combination of the following: physical gestures, audio, text, doodles, graphic images, selection from a group of an emoji, object or image.

In some embodiments, the method further comprises applying the artificial intelligence to score the user's input in a particular language at each of a plurality of stages of the input.

In some embodiments, the images are in a comic book format.

In some embodiments, the images are in at least one of the following formats: animated clips, cartoons, newspaper, Tiktok style or Snapchat style clip.

In some embodiments, the prompting by the bot is by a visual avatar.

Another embodiment is a computer implemented method for teaching/improving language skills using an interactive process that generates one or more images, the method comprising: prompting, by a bot/processor, a verbal or non-verbal user input; applying a transcription algorithm configured to convert the user input to text; analyzing, by the processor, the text, and if the text fails to meet a predefined language quality standard, prompting further verbal or non-verbal user input comprising an improved text by suggesting an improved text, asking a leading question or asking for more information, generating, by a processor, one or more images reflecting the text or improved text and presenting the one or more images to the user; and prompting the user to decide if the one or more images captures what the user intended to communicate and, if not, allowing the user to re-input the user input.

In some embodiments, the predefined language quality standard is not met if the text is unclear, incomplete or has improper grammar.

In some embodiments, the user input has multiple parts inputted at different times and for each part of the user input the processor uses artificial intelligence to match key verbs of the text or improved text derived from the user input with a plurality of newly generated proposed images presented in a visual group to the user, the method further comprising generating, using the processor and the artificial intelligence, a visually connected sequence of images.

In some embodiments, a series of selected matching images is configured to collectively form the visually connected sequence of images.

In some embodiments, each plurality of proposed images presented beginning with a
second plurality of proposed images is configured to integrate data from the user's previous one or more selections of images.

In some embodiments, the user input is in the form of physical gestures.

In some embodiments, the user input is in the form of any combination of the following: audio, text, doodles, graphic images, selection from a group of an emoji, object or image.

In some embodiments, the method further comprises applying the artificial intelligence to score the user's input in a particular language at each of a plurality of stages of the input.

In some embodiments, the one or more images are in a comic book format.

In some embodiments, the one or more images are in at least one of the following formats: animated clips, cartoons, newspaper, Tiktok or Snapchat style clip.

In some embodiments, the prompting by the bot is by a visual avatar.

Another embodiments is a system for teaching language skills using an interactive process that generates a visually connected sequence of images, the system comprising a processor of a processing unit configured to: prompt user input of a selection of a persona and of an activity previously performed by the user; generate, by the processor, an image of a character or an object matching, in activity or pose, the selected persona and activity; prompt, by a bot, an input from a user of a language demonstration that describes the selected activity of the user and that has multiple parts; verify, using conversational artificial intelligence, an integrity of the input, by recognizing key verbs and checking for errors, and provide at least one of feedback and a score measuring a language skill of the input; recognize, using a conversational artificial intelligence, key verbs in the audio input so as to verify an integrity of the audio input; for each part of the language demonstration, use the artificial intelligence and the generated image of the character or object to match the key verbs and selected persona with a plurality of newly generated proposed images presented in a visual group to the user such that a series of selected matching images is configured to collectively form a visually connected sequence of images and such that each plurality of newly generated proposed images presented beginning with a second plurality of proposed images is configured to integrate data from the user's previous one or more selections of images; from the user selections, generate, using the artificial intelligence, the visually connected sequence of images.

In some embodiments of the system, the prompt by the bot includes at least two of the following: what the user did, where the user was, with whom the user interacted, what happened to the user and how the user felt.

In some embodiments, the language demonstration is a story.

In some embodiments, the language demonstration is in the form of physical gestures.

In some embodiments, the language demonstration is in the form of any combination of the following: audio, text, doodles, graphic images, selection from a group of an emoji, object or image.

In some embodiments, the processor is further configured to apply the artificial intelligence to score the user's input in a particular language at each of a plurality of stages of the input.

In some embodiments, the images are in a comic book format.

In some embodiments, the images are in at least one of the following formats: animated clips, cartoons, newspaper, Tiktok style or Snapchat style clip.

In some embodiments, the prompting by the bot is by a visual avatar.

Another embodiment is a system for teaching/improving language skills using an interactive process that generates one or more images, the system comprising a processor of a processing unit configured to: prompt a verbal or non-verbal user input; apply a transcription algorithm configured to convert the user input to text; analyze the text, and if the text fails to meet a predefined language quality standard, prompting further verbal or non-verbal user input comprising an improved text by suggesting an improved text, asking a leading question or asking for more information, generate one or more images reflecting the text or improved text and present the one or more images to the user; and prompt the user to decide if the one or more images captures what the user intended to communicate and, if not, allowing the user to re-input the user input.

In some embodiments of the system, the predefined language quality standard is not met if the text is unclear, incomplete or has improper grammar.

In some embodiments, the processor is further configured to apply artificial intelligence to score the user's input in a particular language at each of a plurality of stages of the input.

In some embodiments, the one or more images are in a comic book format.

In some embodiments, the one or more images are in at least one of the following formats: animated clips, cartoons, newspaper, Tiktok or Snapchat style clip.

In some embodiments, the prompting by the bot is by a visual avatar.

In some embodiments, the user input is in the form of physical gestures.

In some embodiments, the user input is in the form of any combination of the following: audio, text, doodles, graphic images, selection from a group of an emoji, object or image.

In some embodiments, the user input has multiple parts inputted at different times and for each part of the user input the processor uses artificial intelligence to match key verbs of the text or improved text derived from the user input with a plurality of newly generated proposed images presented in a visual group to the user, the method further comprising generating, using the processor and the artificial intelligence, a visually connected sequence of images.

In some embodiments, a series of selected matching images is configured to collectively form the visually connected sequence of images.

In some embodiments, each plurality of proposed images presented beginning with a second plurality of proposed images is configured to integrate data from the user's previous one or more selections of images.

### BRIEF DESCRIPTION OF THE DRAWINGS

Various embodiments are herein described, by way of example only, with reference to the accompanying drawings, wherein:

FIG. 1 is an image of a visual avatar used to prompt the user to start the adventure, in accordance with one embodiment;

FIG. 2 is a comic book page generated for a user's content and selected images, in accordance with one embodiment;

FIG. 3 is another comic book page generated for a user's content and selected images, in accordance with one embodiment;

FIG. 4 is a screen prompting a user to start an activity by selecting a superhero alongside images of selectable superheroes, in accordance with one embodiment;

FIG. 5 is a dialog box of options for selecting an activity, in accordance with one embodiment;

FIG. 6 is a screen image prompting a live transcription of the user's voice describing an activity and follow-up interaction, in accordance with one embodiment;

FIG. 7 is a screen describing an activity and a screen prompting a child's selection among four images to express that activity, in accordance with one embodiment;

FIG. 8 is a gallery of all saved comic book pages, in accordance with one embodiment;

FIG. 9 is a flow chart of a method in accordance with one embodiment;

FIG. 10 is a flow chart of another method, in accordance with one embodiment; and

FIG. 11 is a schematic drawing of a system, in accordance with one embodiment.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain embodiments are directed to a computer implemented method or system for teaching/improving language skills using an interactive process that generates one or more images. The method may be used for educationally challenged students or children with special educational needs but may also be used for students of all kinds, including adults who want to learn a second language. In certain embodiments, the method or system may involve developing language skills by taking a text or other language related input by the user/student and generating an image or a visually connected series of images. In some cases the images reflect events or activities that took place just recently in the life of the student or user. This enhances the interest of the user, child or other student and makes it the learning process more stimulating.

Certain embodiments introduce a novel, engaging and interactive process or system that drives people to use and reuse the process/system over time. The activity is directed towards self-practice, although in different cases, such as in special education, it could be used in a semi-guided manner. The goal of this activity is to complete a set of language specific pre-defined tasks, that in certain embodiments will result in a visually connected sequence of images in one of a variety of stimulating formats, for example in the form of a comic-book page (FIG. 2 and FIG. 3) based on the content supplied by the user. During the activity data is collected from the user (audio, mistakes, correction) to supply real-time feedback and measurements for the activity (the measurements may be in the form of a sum of scores for each sub-task).

Certain embodiments are directed to a computer implemented method or system for teaching/improving language skills using an interactive process that generates one or more images such as by prompting, by a bot/processor, a verbal or non-verbal user input, applying a (personalized) transcription algorithm configured to convert the user input to text, analyzing, by the processor, the text, for example using NLP, and if the text fails to meet a predefined language quality standard, prompting, for example by a visual avatar, further verbal or non-verbal user input comprising an improved text by suggesting an improved text, asking a leading question or asking for more information, generating, by a processor, one or more images reflecting the text or improved text and presenting the one or more images to the user; and prompting the user to decide if the one or more images captures what the user intended to communicate and, if not, allowing the user to re-input the user input.

In some implementations, the prompting includes at least two of the following: what the user did, where the user was, with whom the user interacted, what happened to the user and how the user felt. The language demonstration may be a story. The language demonstration is in the form of any combination of the following: audio, text, physical gestures, doodles, graphic images, selection from a group of an emoji, object or image.

The method may comprise applying the artificial intelligence to score the user's input in a particular language at each of a plurality of stages of the input.

In one particular implementation of the method or system, the images are in a comic book format. In general the images are in at least one of the following formats: comic book format, animated clips, cartoons, newspaper, Tiktok or Snapchat style clip. “Tiktok” as a format refers herein to the format of the video clips used in the Chinese video hosting service by the same name. “Snapchat” as a format refers to the format of the pictures and messages of the American instant messaging app and service of the same name.

One example in which the images are generated in a comic book format is described as follows:

Before initializing the activity, the user selects a super-hero (one out of n super-heroes supplied) that will play his role in the generated comic-book story. During each sub-task of the activity, for example one generated sentence, immediate feedback is supplied based on the goals defined in the activity and n comic style images will be created for the student to pick from.

By the end of the activity all selected images will be accumulated into a comic-book page (FIG. 2 and FIG. 3).

Each user will have a library of all his generated comic-book pages, that he could download, print, or generate a full-story comic-book journal. As an example, users can convert their weekend stories into a comic-book, that could also be their private diary.

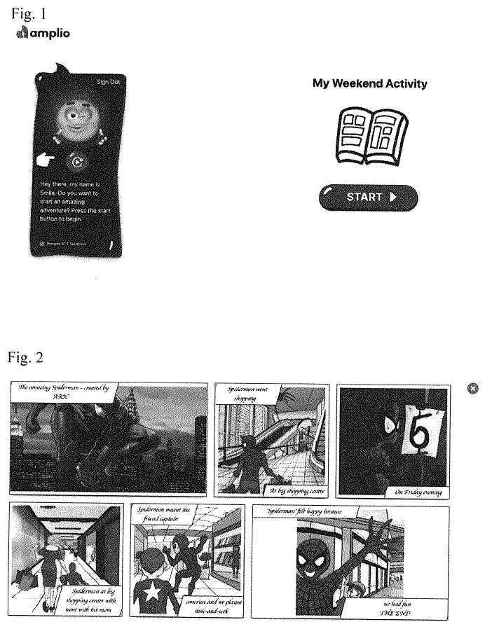

The activity is fully guided by a friendly avatar, speaking, and showing facial emotions, directing the user, and suppling feedback accordingly. The following technologies may be used: Text to speech, speech to text (real-time transcription), conversational AI/smart bot, toxicity validation (checking the user's input to determine if content contains anything offensive), visual avatar (capable of showing facial emotions and mouth movements—FIG. 1), NLP services—for example summarization, grammar checking, proof reading, third person conversions (converting from the first person to the third person).

In this embodiment, all user interaction is audio based, meaning user is approached by the avatar, directing him to do something, the user responds with his voice (after clicking a microphone button), the system automatically detects when the user stops speaking, presenting him with approve/disapprove buttons. Optionally, for non-reading users, after each user's answer the system will read aloud what it detected for the user to approve or try again.

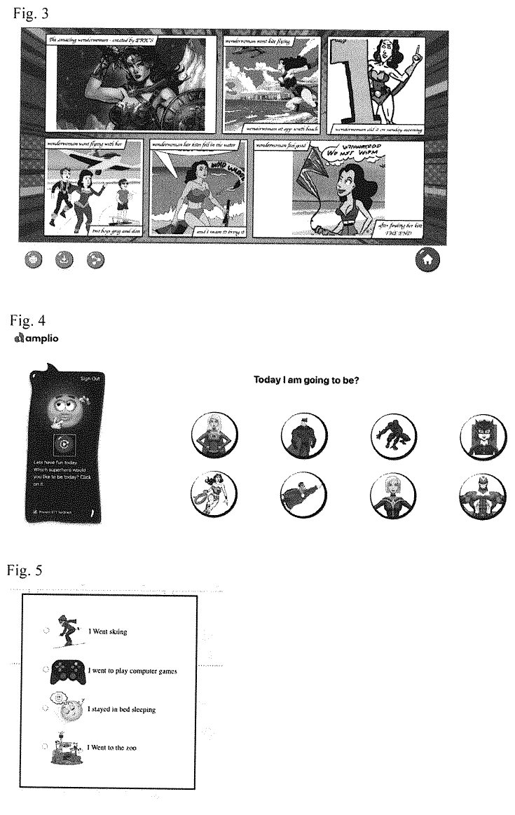

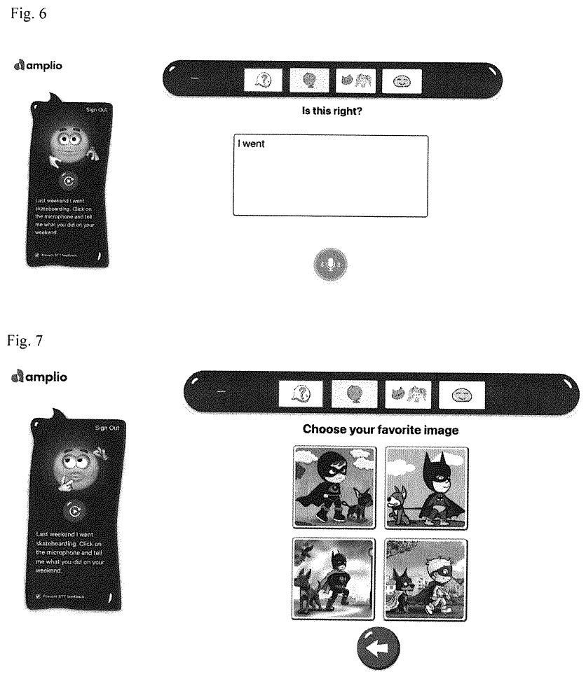

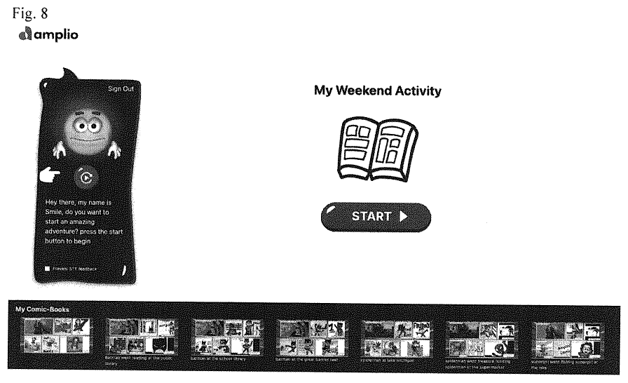

An example of the process is provided below using a weekend storytelling concept in the context of the visually connected sequence of images being in a comic book format but it should be understood that the use of a “story” is just one example and the use of a “comic-book format” is just one example of a stimulating format:
1. User logs-in or being logged-in (semi-guided).
2. User is asked by a friendly avatar to enter his name (FIG. 4).
3. User is asked by a friendly avatar to choose his super-hero for the activity (FIG. 4).
4. User is directed to the first and is being asked by the avatar if he wants to hear what happened to him on the weekend. The purpose here is to supply a live example of the full process with explained details on each section.
5. User starts the activity and is navigated to the first step. The user is greeted by the avatar and is told what to do: “tell me what you did in this week”.
6. User clicks on the microphone and tells his part.
7. While speaking user's voice transcript, at real-time (FIG. 6), into text, displayed in front of him.
8. Data is validated by a bot service, checking if the sentence includes the required content:
   Toxicity check if data is not offensive (toxicity service)
   Includes a verb
   Includes a relevant activity
9. If data is missing or corrupted, the user will receive relevant feedback to try again, each retry will count as a strike for that step. After x {1, 2, . . . n} tries the user will be presented with a list of pre-set options to select (FIG. 5), enabling him to proceed to the next step.
10. If data is valid y {1, 2, . . . n} comic style images (FIG. 7) are presented to the user, asking him to select his favorite image and then he will be moved to the next step.
11. The cycle continues for each step from items numbered 6 to 9 (the cycle of prompting the user to say the required part, convert it to text, validate the transcription with the user, analyze the text for grammar and toxicity and generate a set of images for the user to select). As an example of steps, in the weekend storytelling narrative activity the steps could be: “what” you did, “where” you did it, “when” you did it, “with” who did you do it, “what” happened to you there, how it made you “feel” and a “summarization” of the full story.
12. After the final step a comic-book page of the users selected images and his content will be displayed to the user, with options to download and print it.
13. The comic-book page will be added to the user's personal gallery (FIG. 8), enabling him to return to it at any time.
14. The user will be navigated to the home page, where he could start a new activity or go back to one of his previous comic-book pages.

Unlike text to art services, (achieving generation of images in the same context) that convert a given text description into a visual image but perform a single operation that does not relate to previous commands and where even for the exact same given text, different images will be generated on each try, the comic-book page here generates images that take into consideration earlier steps in the story or other input so as to achieve a similar visual display for all images in the comic-book page.

In certain embodiments, the superhero persona is used as an anchor for all images.

Bot entities (location, time, person, etc.) collected from the text may be anchors to the next steps. For example, the activity type, its location, time of day we be used in the “with whom you did it” step. For example, if the child or other user inputs text stating “with my friends Dan and George” in response to the question “with whom did you do” the activity, then the system may generate a “Cartoon of Spiderman fishing at lake Tahoe on Friday morning with his friends Dan and George”. In another example, at each step the user adds information to the story like the activity he did. The app logic captures from the whole text the relevant parts, such as fishing (or eating, or playing etc.) and uses it in the next parts, for example by asking the user the next follow-up question such as “Where did you go fishing?”.

In some embodiments, the toxicity validation is requested by third party services to prevent or block inappropriate descriptions.

One particular embodiment is a computer implemented method 100 for interactively teaching/improving language skills by generating a visually connected sequence of images. The images may concern an activity, for example a recent activity in the student or child's life.

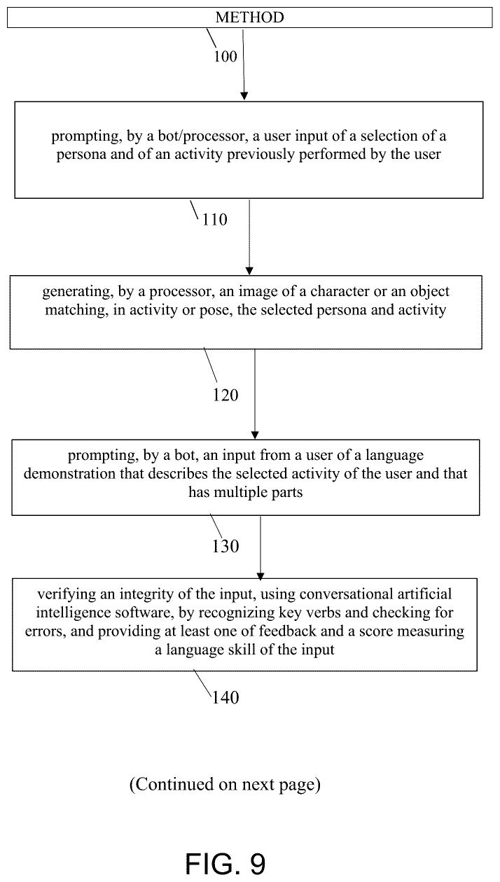

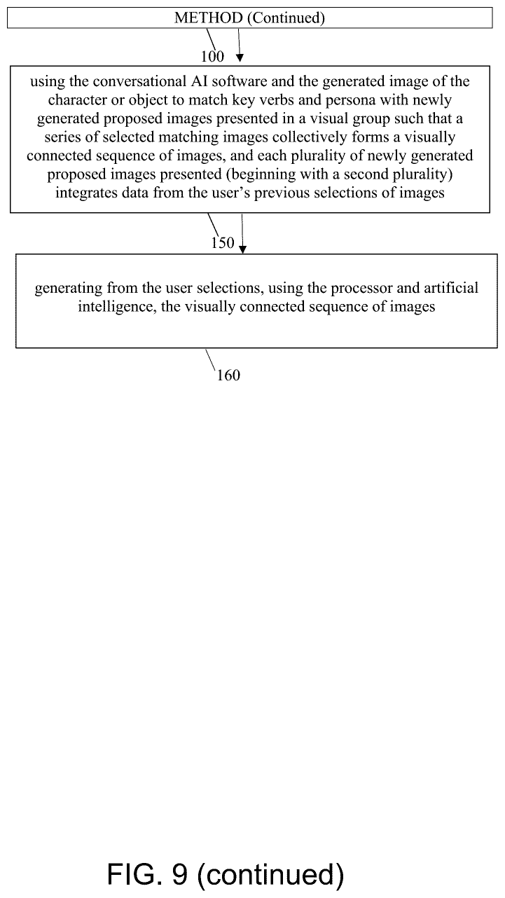

As shown in FIG. 9, method 100 may comprise a step 110 of prompting, by a bot or a processor, a user input of a selection of a persona and of an activity previously performed by the user, i.e. the student or child.

A further step 120 may be generating, by a processor, an image of a character or an object matching, in activity or pose, the selected persona and activity.

A step 130 may comprise prompting, by a bot, an input from a user of a language demonstration that describes the selected activity of the user and that has multiple parts. The language demonstration may be a brief description of an activity that the child just recently did, for example. The language demonstration may also be nontextual. For example, audio prompts, physical gestures by the child (in one nonlimiting example drawing in the air) that are detected by an image analysis, doodle drawings, presentation of images or objects by the child. The child may also select emojis from a list.

In some embodiments, the processor is configured with special program instructions stored on memory in which the movement of the user's joints and/or the movement of the user's fingers or finger are detected and analyzed by an image analysis module. Applicant has discovered that especially, but not necessarily exclusively, with children that are dyslectic multi-sensor stimuli, in contrast to repetition of single sensor stimuli, greatly enhances the learning process.

Another step 140 of method 100 may include verifying an integrity of the input, using conversational artificial intelligence software, by recognizing key verbs and checking for errors, and providing at least one of feedback and a score measuring a language skill of the input.

In a further step 150, for each part of the language demonstration, using the conversational artificial intelligence algorithm (conversational artificial intelligence software) and the generated image of the character or object to match the key verbs and selected persona with a plurality of newly generated proposed images presented in a visual group to the user such that a series of selected matching images is configured to collectively form a visually connected sequence of images, and such that each plurality of newly generated proposed images that is presented (beginning with a second plurality of proposed images) is configured to integrate data from the user's previous one or more selections of images. In one implementation the newly generated proposed images presented in a visual group may be one or more of cartoons, animated clips, newspaper photos or images, Tiktok-style clips, Snapchat-style clips or another format.

A step 160 may include generating from the user selections, using the processor and artificial intelligence, the visually connected sequence of images. The visually connected sequence of images may be a variety of formats such as cartoons, animated clips, newspaper images, Tiktok-style clips or Snapchat-style clips.

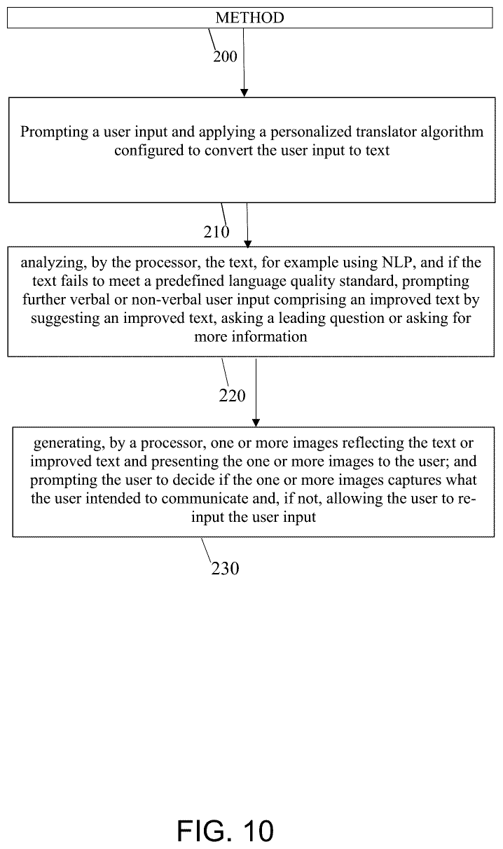

Another embodiment shown in FIG. 10 is a computer implemented method for teaching/improving language skills using an interactive process that generates one or more images. A first step 210 of method 200 may comprise prompting, by a bot/processor, a verbal or non-verbal user input and applying a personalized translator algorithm (transcription algorithm) configured to convert the user input to text.

Step 220 may include analyzing, by the processor, the text, for example using NLP, and if the text fails to meet a predefined language quality standard, prompting further verbal or non-verbal user input comprising an improved text by suggesting an improved text, asking a leading question or asking for more information.

Another step 230 may comprise generating, by a processor, one or more images reflecting the text or improved text and presenting the one or more images to the user and prompting the user to decide if the one or more images captures what the user intended to communicate and, if not, allowing the user to re-input the user input.

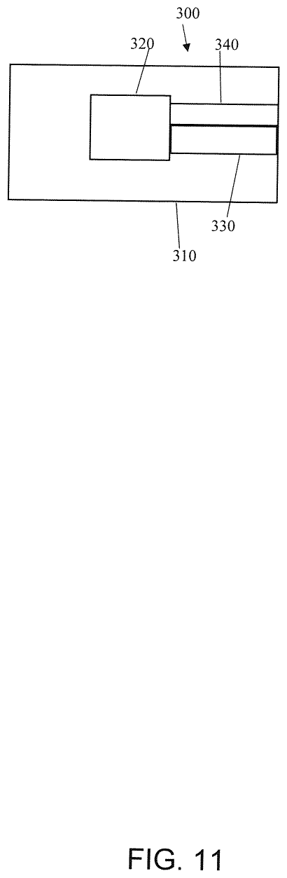

As seen in FIG. 11, a system 300 for teaching language skills using an interactive process that generates a visually connected sequence of images may comprise a processing unit 310 that includes a processor 320 configured to perform certain actions by executing program instructions 340 stored on a memory 330, for example a non-transitory storage medium 330. The program instructions are configured to perform the following steps when executed by the processor 320.

In one embodiment, the processor or bot is configured to prompt (for example by a visual avatar) a verbal or non-verbal user input;
apply a transcription algorithm configured to convert the user input to text;
analyze the text, for example using NLP, and if the text fails to meet a predefined language quality standard, prompting further verbal or non-verbal user input comprising an improved text by suggesting an improved text, asking a leading question or asking for more information,
generate one or more images reflecting the text or improved text and present the one or more images to the user; and
prompt the user to decide if the one or more images captures what the user intended to communicate and, if not, allowing the user to re-input the user input.

As with the methods described herein, in system 300, the prompt by the bot may include at least two of the following: what the user did, where the user was, with whom the user interacted, what happened to the user and how the user felt. The language demonstration may be a story, may be in the form of any combination of the following: audio, text, doodles, graphic images, selection from a group of an emoji, object or image, physical gestures.

The processor 320 may be further configured to apply the artificial intelligence to score the user's input in a particular language at each of a plurality of stages of the input.

In some embodiments, the images are in at least one of the following formats: comic book format, animated clips, cartoons, newspaper, Tiktok style or Snapchat style clip.

Another embodiment of a system is for teaching language skills using an interactive process that generates a visually connected sequence of images. The system may comprise a processing unit 310 that includes a processor 320 configured to perform certain actions by executing program instructions 330 stored on a memory 340 for example a non-transitory storage medium 340. The program instructions are configured to perform the following steps when executed by the processor 320:
prompt user input of a selection of a persona and of an activity previously performed by the user;
generate, by the processor, an image of a character or an object matching, in activity or pose, the selected persona and activity;
prompt, by a bot, an input from a user of a language demonstration that describes the selected activity of the user and that has multiple parts;
verify, using conversational artificial intelligence, an integrity of the input, by recognizing key verbs and checking for errors, and provide at least one of feedback and a score measuring a language skill of the input;
recognize, using a conversational artificial intelligence, key verbs in the audio input so as to verify an integrity of the audio input;
for each part of the language demonstration, use the artificial intelligence and the generated image of the character or object to match the key verbs and selected persona with a plurality of newly generated proposed images presented in a visual group to the user such that a series of selected matching images is configured to collectively form a visually connected sequence of images and such that each plurality of newly generated proposed images presented beginning with a second plurality of proposed images is configured to integrate data from the user's previous one or more selections of images;
from the user selections, generate, using the artificial intelligence, the visually connected sequence of images.

According to some embodiments, the output may be printed or shared via social network to physically present the student's generated output.

According to some embodiments, single generated pages (such as, for example, comic book pages), may be grouped into a full comic book, based on multiple sessions. In some exemplary embodiments, such grouped product, can be a student's diary played by a superhero.

According to some embodiments, generated stories may be performed in parts as a group session, where each student is responsible for a specific part/portion of a story. In other examples, a student can receive a summary of the story generated by the previous student and continue it from that point.

According to some embodiments, generated stories can be part of a “best story” competition between various groups (schools, regions, fraternities, etc.).

According to some embodiments, story generation can include the bot filling-in parts, as a beginning point and/or as an ending, the student's task to continue from starting point, fill the blank between the start and end points, etc.

According to some embodiments, initiation of a story can be imported as input from the students' other connected digital work, like his other activities or notebook.

According to some embodiments, the transcription algorithm may utilize AI algorithms to convert human speech into text. According to some embodiments, various machine learning, natural language processing (NLP) and/or Large Language Models (LLMs) algorithms may further be utilized.

According to some embodiments, as a non-limiting example, an NLP and Large Language Models (LLMs) models may include Bidirectional Encoder Representations from Transformers (BERT), Robustly Optimized BERT Pretraining Approach (RoBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT) Dialog Flow or any combination thereof.

According to some embodiments, artificial intelligence (AI) model may be selected from convolutional neural network (CNN), recurrent neural network (RNN), long-short term memory (LSTM), auto-encoder (AE), generative adversarial network (GAN), Reinforcement-Learning (RL) and the like. In other embodiments, the specific algorithms may be implemented using machine learning methods, such as support vector machine (SVM), decision tree (DT), random forest (RF), and the like. Each possibility and combination of possibilities is a separate embodiment. Both “supervised” and “unsupervised” methods may be implemented.

Although some embodiments of the invention are not limited in this regard, discussions utilizing terms such as, for example, “processing,” “computing.” “calculating,” “determining,” “establishing”. “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although stages of methods, according to some embodiments, may be described in a specific sequence, the methods of the disclosure may include some or all of the described stages carried out in a different order. In particular, it is to be understood that the order of stages and sub-stages of any of the described methods may be reordered unless the context clearly dictates otherwise, for example, when a latter stage requires as input an output of a former stage or when a latter stage requires a product of a former stage. A method of the disclosure may include a few of the stages described or all of the stages described. No particular stage in a disclosed method is to be considered an essential stage of that method, unless explicitly specified as such.

While the invention has been described with respect to a limited number of embodiments, it will be appreciated that many variations, modifications and other applications of the invention may be made. Therefore, the claimed invention, as recited in the claims that follow, is not limited to the embodiments described herein.

What is claimed is:

1. A computer implemented method for interactively teaching or improving language skills by generating a visually connected sequence of images, the method comprising:
prompting, by a bot or a processor, a user input of a selection of a persona and of an activity previously performed by the user;
generating, by a processor, an image of a character or an object matching, in activity or pose, the selected persona and activity;
prompting, by a bot, an input from a user of a language demonstration that describes the selected activity of the user and that has multiple parts;
verifying an integrity of the input, using conversational artificial intelligence algorithm, by recognizing key verbs and checking for errors, and providing at least one of feedback and a score measuring a language skill of the input;
for each part of the language demonstration, using the conversational artificial intelligence algorithm and the generated image of the character or object to match the key verbs and selected persona with a plurality of newly generated proposed images presented in a visual group to the user such that a series of selected matching images is configured to collectively form a visually connected sequence of images, and such that each plurality of newly generated proposed images presented beginning with a second plurality of proposed images is configured to integrate data from the user's previous one or more selections of images; and
generating from the user selections, using the processor and artificial intelligence algorithm, the visually connected sequence of images.

2. The method of claim 1, wherein the prompting includes at least two of the following: what the user did, where the user was, with whom the user interacted, what happened to the user and how the user felt.

3. The method of claim 1, wherein the language demonstration is a story.

4. The method of claim 1, wherein the language demonstration is in the form of: physical gestures, audio, text, doodles, graphic images, selection from a group of an emoji, object or image, or any combinations thereof.

5. The method of claim 1, further comprising applying the artificial intelligence algorithm to score the user's input in a particular language at each of a plurality of stages of the input.

6. The method of claim 1, wherein the images are in a comic book format.

7. The method of claim 1, wherein the images are in at least one of the following formats: comic book format, animated clips, cartoons, newspaper, Tiktok, Snapchat style clip, or any combinations thereof.

8. The method of claim 1, wherein the prompting by the bot is by a visual avatar.

9. A system for teaching language skills using an interactive process that generates a visually connected sequence of images, the system comprising a processor of a processing unit configured to execute the method of claim 1.

10. A non-transitory computer-readable medium storing processor executable instructions on a computing device, when executed by a processor, the processor executable instructions causing the processor to perform the method of claim 1.

11. A computer implemented method for teaching or improving language skills using an interactive process that generates one or more images, the method comprising:
prompting, by a bot, a verbal or non-verbal user input;
applying a transcription algorithm configured to convert the user input to text;
analyzing, by the processor, the text, and if the text fails to meet a predefined language quality standard, prompting further verbal or non-verbal user input comprising an improved text by suggesting an improved text, asking a leading question or asking for more information,
generating, by a processor, one or more images reflecting the text or improved text and presenting the one or more images to the user; and
prompting the user to decide if the one or more images captures what the user intended to communicate and, if not, allowing the user to re-input the user input.

12. The method of claim 11, wherein the predefined language quality standard is not met if the text is unclear, incomplete or has improper grammar.

13. The method of claim 11, wherein the user input has multiple parts inputted at different times and for each part of the user input the processor uses artificial intelligence to match key verbs of the text or improved text derived from the user input with a plurality of newly generated proposed images presented in a visual group to the user, the method further comprising generating, using the processor and the artificial intelligence, a visually connected sequence of images.

14. The method of claim 13, wherein a series of selected matching images is configured to collectively form the visually connected sequence of images.

15. The method of claim 13, wherein each plurality of proposed images presented beginning with a second plurality of proposed images is configured to integrate data from the user's previous one or more selections of images.

16. The method of claim 11, wherein the user input is in the form of physical gestures, audio, text, doodles, graphic images, selection from a group of an emoji, object or image, or any combinations thereof.

17. The method of claim 11, further comprising applying a score the user's input in a particular language at each of a plurality of stages of the input.

18. The method of claim 11, wherein the one or more images are in at least one of the following formats: a comic book format, animated clips, cartoons, newspaper, Tiktok style, Snapchat style clip, or any combination thereof.

19. The method of claim 11, wherein the prompting by the bot is by a visual avatar.

20. A system for teaching or improving language skills using an interactive process that generates one or more images, the system comprising a processor of a processing unit configured to execute the method of claim 11.
